(19) United States
(12) Patent Application Publication
(10) Pub. No.: US 2026/0104150 A1
(43) Pub. Date: Apr. 16, 2026

(54) ADAPTIVE LIGHTING SYSTEM

(71) Applicant: Tesla, Inc., Austin, TX (US)

(72) Inventors: John G. Ring, Walnut Creek, CA (US); Javier Verdura, Palos Verdes, CA (US)

(21) Appl. No.: 18/916,172

(22) Filed: Oct. 15, 2024

(51) Int. Cl. F21S 41/64; F21S 41/20

(52) U.S. Cl. CPC F21S 41/64; F21S 41/285

(57) ABSTRACT

A lighting system that comprises a chromic dye applied to a lens of a light assembly. The chromic dye is configured to transition between different optical states in response to trigger stimuli.

### TECHNICAL FIELD

Examples of the present disclosure relate generally to the field of vehicle lighting systems.

### BACKGROUND

The present disclosure pertains to the field of lighting technology, with a particular focus on systems that enhance the adaptability and efficiency of lighting in various applications such as automotive, architectural, and public spaces.

Current lighting systems often utilize static configurations and conventional materials that limit their ability to adapt to changing environmental conditions. For instance, in automotive applications, the visibility of lighting elements under different lighting conditions can affect both the aesthetic appeal of the vehicle and the safety of road users. Traditional systems do not adequately address the need for lighting elements that can dynamically adjust to varying levels of ambient light.

These limitations highlight a significant problem: the inability of current lighting systems to provide optimal visibility and aesthetic integration under diverse conditions. This is particularly critical in industries where safety and design are paramount, such as in automotive manufacturing.

### BRIEF DESCRIPTION OF THE SEVERAL VIEWS OF THE DRAWINGS

Throughout the drawings, reference numbers may be re-used to indicate correspondence between referenced elements. The drawings are provided to illustrate examples of the subject matter described herein and not to limit the scope thereof.

FIG. 1 is a diagram depicting an example of an adaptive lighting system, according to certain examples.

FIG. 2 is a diagram depicting phase states of a chromic element, according to certain examples.

FIG. 3 is a diagram depicting an example of an adaptive lighting system, according to certain examples.

### DETAILED DESCRIPTION

The present disclosure relates to an adaptive lighting system designed to enhance the functionality and adaptability of light assemblies, particularly in vehicles and other settings requiring dynamic lighting solutions. According to certain examples, the system incorporates a chromic element to adjust optical properties in response to various trigger stimuli.

In some examples, the lighting system comprises a light assembly that includes at least one light source to emit light. A lens may be positioned in front of the light source, and in some examples a chromic element is disposed proximally to the lens.

In some examples, the chromic element comprises a photochromic dye, which responds to light within certain spectrums of light. This feature may be particularly beneficial for automotive applications where the visibility of lighting elements can significantly impact both the vehicle's aesthetic appeal and safety. For example, the photochromic dye may transition to a darker state under strong sunlight, reducing the visibility of the lighting elements, and returns to a clearer state in lower light conditions, or responsive to a trigger stimulus that includes exposure to light within a spectrum that corresponds to light emitted by a light source of the lighting system.

The chromic element may include a photochromic dye that comprises a sensitizer that possesses an absorption spectrum specifically designed to match the emission spectrum of the light emitted by the light source. In some examples, the chromic element is responsive to the specific wavelengths produced by the light source, enabling a more precise and efficient transition between its different states.

In some examples, the chromic element comprises a photochromic dye that comprises chemical composition that includes at least one functional group designed to enhance the sensitivity of the chromic element to the emission spectrum of the light source. A functional group refers to specific chemical groups or moieties within the chemical composition of the chromic element that are responsible for enhancing its sensitivity to the emission spectrum of the light source. For example, the functional groups may interact specifically with certain wavelengths of light emitted by the light source, enabling the chromic surface to change its optical properties (such as color or transparency) more effectively and responsively.

The light source of the light assembly may emit a spectrum of light that interacts with the chromic element, such that the chromic element transitions between its states—opaque and transparent—based on exposure to the light emitted by the light source itself. Accordingly, in such examples the lighting system may adapt automatically to the operational conditions without the need for external sensors or additional control mechanisms. In automotive applications, the chromic element of the light assembly can automatically adjust transparency based on the light emitted by the lighting system itself.

In some examples, the chromic element may include an electrochromic dye, which change their optical properties in response to electrical stimuli. This variation allows for greater control over the lighting conditions, particularly in environments where manual adjustment is feasible or desired.

In some examples, the chromic element may include one or more of: a liquid crystal (LC) panel positioned proximally to the lens; a suspended particle device (SPD) film applied to the surface of the lens; and a polymer-dispersed liquid crystal (PDLC) panel disposed proximally to the lens.

According to certain examples, the system is designed to be used in various configurations, such as in lightbars of vehicles, where the adaptability can significantly improve the functionality of emergency or specialized vehicles. The trigger stimuli for these transitions can also include electrical inputs from the vehicle, allowing for seamless integration with existing vehicle control systems in some examples.

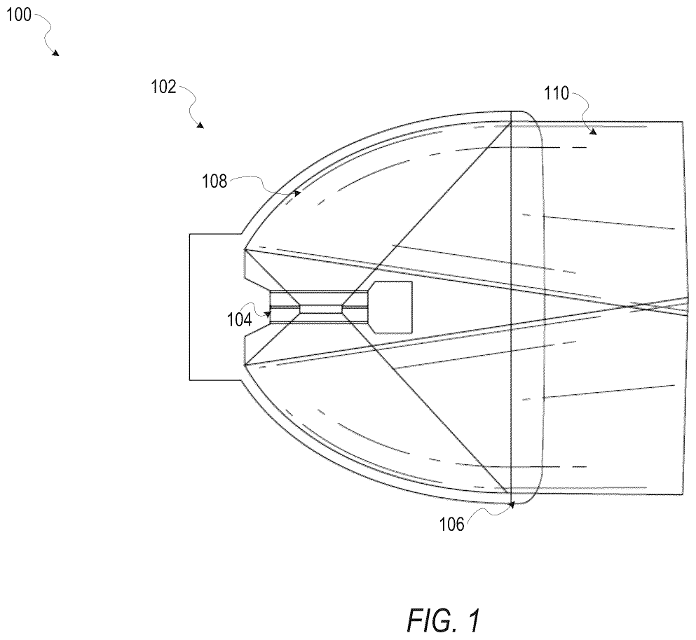

FIG. 1 is a diagram 100 depicting an example of an adaptive lighting system 102, according to certain examples. As seen in the diagram 100, the adaptive lighting system 102 may comprise a light source 104, a lens 106, and a reflector 108. Accordingly, the adaptive lighting system 102 may emit light 110, wherein the light 110 comprises light within an emission spectrum.

According to certain examples, the light source 104 emits the light 110. The light 110 emitted encompasses a specific emission spectrum, wherein the emission spectrum of light 110 can be tailored to trigger responses from a chromic element, such as a chromic dye applied to the lens 106.

Positioned in front of the light source 104, in some examples the lens 106 is equipped with a chromic element, such as a chromic dye or film applied to a surface of the lens, or in some examples a chromic panel disposed proximally to an interior or anterior surface of the lens 106. The chromic element is configured to transition between different states (e.g., opaque and transparent) in response to trigger stimuli that may include the emission spectrum of light 110.

According to certain examples, the chromic element may include one or more of a photochromic, or electrochromic surface. For example the lens 106 may incorporate a photochromic surface that reacts to light, an electrochromic surface that changes properties with electrical stimuli, or other chromic materials like liquid crystal (LC) panels, suspended particle device (SPD) films, or polymer-dispersed liquid crystal (PDLC) panels. These materials enable the lens 106 to adjust its transparency and coloration dynamically, enhancing the system's adaptability to environmental changes.

In some examples, the chromic element may comprise a chemical composition that includes sensitizers or functional groups that enhance its sensitivity to the specific emission spectrum of light 110. In some examples, these chemical modifications enable the chromic surface responds more effectively to the light emitted by the light source 104.

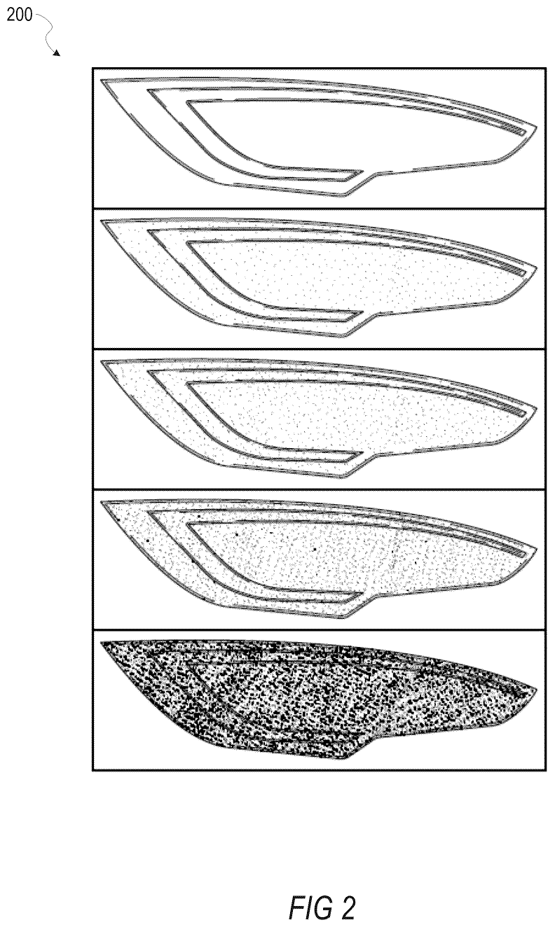

FIG. 2 is a diagram 200 depicting phase states of a chromic element, according to certain examples. As seen in the diagram 200, the chromic element may progress from a transparent state to high opacity state.

According to certain examples as depicted in the diagram 200, the chromic element may begin in a high opacity state, wherein the chromic element is darkened to reduce light transmission. The chromic element may in some examples transition through several intermediate states, to progressively lighten to adjust the light transmission suitable for varying environmental conditions or based on light emitted by the lighting system.

In some examples, the sequence may culminate in a transparent state which provides maximum light transmission of light from the light source of the lighting system through the lens.

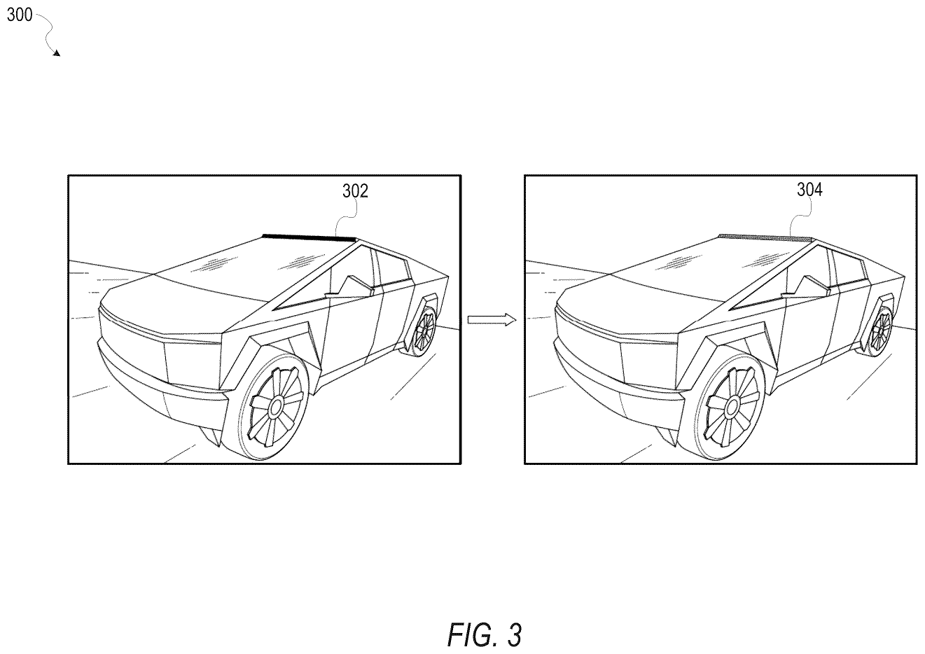

FIG. 3 is a diagram 300 depicting an example of an adaptive lighting system, according to certain examples. The diagram 300 illustrates the adaptive lighting system in a first state 302, wherein the first state 302 comprises a high opacity state with low light transmission, and a second state 304, wherein the second state 304 comprises a transparent state with high light transmission.

### EXAMPLES

Example 1 includes a lighting system comprising: a light assembly that comprises at least one light source to emit light; a lens positioned in front of the at least one light source; and a chromic surface disposed proximally to the lens, the chromic surface being configured to transition between a first state and a second state based on a trigger stimulus.

In Example 2, the subject matter of Example 1, wherein the chromic surface comprises a photochromic surface applied to a surface of the lens.

In Example 3, the subject matter of Example 1, wherein the chromic surface comprises an electrochromic surface applied to a surface of the lens.

In Example 4, the subject matter of Example 1, wherein the chromic surface comprises a liquid crystal (LC) panel disposed proximally to the lens.

In Example 5, the subject matter of Example 1, wherein the chromic surface comprises a suspended particle device (SPD) film applied to a surface of the lens.

In Example 6, the subject matter of Example 1, wherein the chromic surface comprises a polymer-dispersed liquid crystal (PDLC) panel disposed proximally to the lens.

In Example 7, the subject matter of any of Examples 1-6, wherein the first state comprises an opaque state and the second state comprises a transparent state.

In Example 8, the subject matter of any of Examples 1-7, wherein the light emitted by the at least one light source comprises an emission spectrum, and wherein the trigger stimulus that causes the chromic surface to transition from the first state to the second state includes exposure to the light within the emission spectrum.

In Example 9, the subject matter of any of Examples 1-8, wherein the chromic surface comprises a sensitizer that comprises an absorption spectrum that matches an emission spectrum of the light emitted by the at least one light source.

In Example 10, the subject matter of any of Examples 1-9, wherein the light comprises an emission spectrum, and wherein the chromic surface comprises a chemical composition that includes at least one functional group to enhance sensitivity of the chromic surface to the emission spectrum of the light.

In Example 11, the subject matter of any of Examples 1-10, wherein the light comprises an emission spectrum, and wherein the chromic surface comprises a chemical composition that includes at least one substituent to enhance sensitivity of the chromic surface to the emission spectrum of the light.

In Example 12, the subject matter of any of Examples 1-11, wherein the trigger stimulus includes an exposure of the chromic surface to ultraviolet (UV) light of the sun.

In Example 13, the subject matter of any of Examples 1-12, wherein the lighting system comprises a lightbar of a vehicle.

In Example 14, the subject matter of Example 10, wherein the trigger stimulus includes an electrical stimulus received from a vehicle.

Example 15 includes a method of operating a lighting system comprising: providing a light assembly that comprises at least one light source, and a lens disposed proximally to the at least one light source, the lens comprising a chromic surface; detecting a trigger stimulus that influences the chromic surface; and transitioning the chromic surface from a first state to a second state responsive to the trigger stimulus.

In Example 16, the subject matter of Example 15, wherein the chromic surface comprises a photochromic surface applied to a surface of the lens.

In Example 17, the subject matter of Example 15, wherein the chromic surface comprises an electrochromic surface applied to a surface of the lens.

In Example 18, the subject matter of any of Examples 15-17, wherein the first state comprises an opaque state and the second state comprises a transparent state.

In Example 19, the subject matter of any of Examples 15-18, wherein light emitted by the at least one light source comprises an emission spectrum, and wherein the trigger stimulus that causes the chromic surface to transition from the first state to the second state includes exposure of the chromic surface to the light within the emission spectrum.

In Example 20, the subject matter of any of Examples 15-19, wherein the chromic surface comprises a sensitizer that comprises an absorption spectrum that matches an emission spectrum of light emitted by the at least one light source.

Example 21 may include an apparatus comprising means to perform one or more elements of a method described in or related to any of the preceding examples or any other method or process described herein.

### GLOSSARY

In this application, the following terms have the following meanings in context.
High Opacity State: A state where light transmission is reduced.
Transparent State: A state where light transmission is increased.
Emission Spectrum: The range of wavelengths emitted by a light source.
Functional Groups: Specific chemical groups that enhance sensitivity to the emission spectrum of a light source.
Sensitizer: A component to increase responsiveness to specific wavelengths of light.

While the above is a detailed description of some examples of the inventive subject matter, various alternatives, modifications, and equivalents may be used. Therefore, the above description should not be taken as limiting the scope of the inventive subject matter which is defined by the appended claims.

1. A lightbar of a vehicle comprising:
a light assembly that comprises at least one light source to emit light within an emission spectrum;
a lens positioned in front of the at least one light source; and
a chromic panel that comprises a photochromic surface that comprises a suspended particle device (SPD) film applied directly to a surface of the lens, the chromic panel comprising a photochromic dye that comprises a sensitizer that possesses an enhanced sensitivity to a specific wavelength of light within the emission spectrum of the light emitted by the light source, wherein the sensitizer comprises an absorption spectrum that is substantially equivalent to the emission spectrum of the light emitted by the light source, and wherein the photochromic dye comprises a chemical composition that includes at least one functional group designed to enhance sensitivity of the photochromic dye to the emission spectrum of the light source, to cause a property of the chromic panel to transition between a first state that comprises an opaque state and a second state that comprises a transparent state responsive to a trigger stimulus that comprises the specific wavelength of the light emitted by the light source, wherein the chromic panel adapts automatically without external sensors or control mechanisms.

2. The lighting system of claim 1, wherein the chromic surface comprises a photochromic surface.

3.-9. (canceled)

10. The lighting system of claim 8, wherein the sensitizer includes at least one functional group to enhance sensitivity of the chromic surface to the emission spectrum of the light.

11. The lighting system of claim 1, wherein the light comprises an emission spectrum, and wherein the chromic surface comprises a chemical composition that includes at least one substituent to enhance sensitivity of the chromic surface to the emission spectrum of the light.

12.-14. (canceled)

15. A method of operating a lightbar of a vehicle comprising:
providing a light assembly that comprises at least one light source, a lens, and a chromic panel that comprises a photochromic surface that comprises a suspended particle device (SPD) film applied directly to a surface of the lens, the chromic panel comprising a sensitizer that possesses an enhanced sensitivity to a specific wavelength of light within the emission spectrum of the light emitted by the at least one light source, wherein the sensitizer comprises an absorption spectrum that is substantially equivalent to the emission spectrum of the light emitted by the light source, and wherein the photochromic dye comprises a chemical composition that includes at least one functional group designed to enhance sensitivity of the photochromic dye to the emission spectrum of the light source, to cause a property of the chromic panel to transition between a first state that comprises an opaque state and a second state that comprises a transparent state based on a trigger stimulus that comprises the specific wavelength of the light emitted by the light source, wherein the chromic panel adapts automatically to operational conditions without the need for external sensors or additional control mechanisms;
detecting the trigger stimulus that influences the photochromic dye of the chromic panel; and
transitioning the chromic panel from the first state to the second state responsive to the trigger stimulus.

16. The method of claim 15, wherein the chromic surface comprises a photochromic surface.

17.-20. (canceled)
